(19) United States
(12) Patent Application Publication
(10) Pub. No.: US 2019/0264000 A1
(43) Pub. Date: Aug. 29, 2019

(54) REDUCTION KIT, REDUCING COMPOSITION AND USE OF SAID KIT AND COMPOSITION

(71) Applicants: CENTRE NATIONAL DE LA RECHERCHE SCIENTIFIQUE, Paris (FR); UNIVERSITÉ CLAUDE BERNARD LYON 1, Villeurbanne (FR); UNIVERSITÉ DE STRASBOURG, Strasbourg (FR)

(72) Inventors: David EDOUARD, Dagneux (FR); Louis LEFEBVRE, Lyon (FR); Loïc JIERRY, Strasbourg (FR); Vincent RITLENG, Schiltigheim (FR); Julien KELBER, Strasbourg (FR)

(21) Appl. No.: 16/320,388

(22) PCT Filed: Jul. 25, 2017
(86) PCT No.: PCT/FR2017/052073

§ 371 Date: Jan. 24, 2019

(30) Foreign Application Priority Data
Jul. 25, 2016 (FR) 16 57090

(51) Int. Cl. C08J 9/36; C08J 9/40; C08K 3/38

(52) U.S. Cl. CPC C08J 9/365; C08J 9/40; C08K 3/38; C08J 2201/038; C08J 2375/04; C08J 2465/00; C08J 2205/05

(57) ABSTRACT

Disclosed is a reduction kit including a reducing compound and an open-cell polymer foam, the surface of which includes a polymer having a catechol unit. Also disclosed is a reducing composition including an open-cell foam, the surface of which includes a polymer having a catechol unit, the foam being functionalized by a reducing compound. The use of the kit or composition as a reagent in reduction reactions is also disclosed.

### FIELD OF THE INVENTION

The present invention relates to a novel reduction kit, a novel reduction composition and their use as a reagent of a reduction reaction.

### CONTEXT OF THE INVENTION

Many industrial methods use reduction reactions using reducing compounds as the reactive compound. Typically, these reactions are the reduction of ketones or aldehydes to alcohols, imines, hydrazones, thioesters, acyl chlorides, the purification of wastewater comprising toxic metals, organic compounds or dyes, the reduction of sulfur oxides such as SO₂ sulfur dioxide for the production of sodium dithionite which is a whitening agent. The production of sodium dithionite is the main use of NaBH₄ in industry. The production of nanoparticles, such as gold nanoparticles, is also made from reducing agents (hydrides). The use of hydrides, as a “storage medium” for hydrogen, is also the subject of intense research for industry players. To perform these reduction reactions, a large amount of reducing compounds such as LiH, NaH, NaBH₄, LiAlH₄ or DIBAL-H is required. For example, the annual production of dyes to be processed exceeds 700 000 tonnes.

Not only the necessary amount of reducing compounds is important but they are used in very large excess in industrial methods because the partially aqueous conditions of use degrade them. It is also necessary to implement sophisticated separation steps to separate reduced reducing compounds from the recoverable products obtained by the reduction reaction. On the other hand, these hydrides are generally prepared in solution, which reduces the risks associated with the prolonged storage of large quantities of these reagents (more stable in solution than in solid form). The current use of reducing compounds is therefore unsatisfactory because it poses problems of cost, safety and environment. In the current ecological and economic context, the development of new reducing compounds, cleaner, more selective, less dangerous, and less expensive has become a major societal challenge.

To solve these problems, reducing compositions comprising a supported reducing compound have, for example, been developed. Thus reducing compositions comprising NaBH₄ supported on alumina (Ref: 243620 ALDRICH) or supported on polymer (Ref: 359947 ALDRICH) are marketed, while a reducing compound comprising NaBH₄ and nano particles (240 nm) of polydopamine has also been studied (S. Du et al—Catalysis Communication, 2015 (DOI: 10.0116/jcatcom 2015.09.020)). However, these reducing compositions are difficult to preserve and expensive to produce because they make use of non-ecological manufacturing methods (preparation of supports, surface modification in organic solvents, use of high temperatures to complete the physisorption methods). In addition, the supports are in the form of powder, particles or balls of small diameter that are fragile and break easily when using magnetic bars, for example in small volume reactors (<1 L). Their use in larger reactors is also prohibited because these supports decant easily and are difficult to disperse in solution in a large reaction volume, in particular when using industrial agitation systems (low speed mechanical stirring). In addition, the separation of these reducing compositions from the recoverable products obtained by the reduction requires sophisticated separation steps (especially for nano/microparticles or powders) and is expensive. The use of these supported hydrides is also difficult to implement in fluid systems because of the significant pressure drop due to the small diameter of the support particles. For these reasons, they can not be used on an industrial scale.

Surprisingly, the Applicant has found a reduction kit that overcomes the disadvantages mentioned. This reduction kit comprises, on the one hand, a reducing compound and, on the other hand, an open cell polymer foam comprising a polymer with a catechol pattern on the surface. This reduction kit has reducing properties that are superior to the reducing properties of the reducing compound and the open-cell polymer foam comprising a polymer with a catechol pattern used separately on the surface. It also significantly reduces the amount of reducing compound used in a reduction reaction. In addition, the reduction kit according to the invention is easily separated from the recoverable products obtained by reduction reaction without implementing a subsequent filtration step. The reduction kit therefore significantly reduces the costs and the environmental impact of the reduction reactions that are widespread in the industry. On the other hand, polymer foam may have elastomeric properties that facilitate its adaptation to all types of reactors.

Thus, the object of the invention is a reduction kit comprising:
on the one hand, a reducing compound, and
on the other hand an open cell polymer foam comprising a catechol pattern polymer on the surface.

The object of the invention is also a reducing composition comprising:
a reducing compound,
an open-cell polymer foam comprising a catechol-patterned polymer on the surface,
   characterized in that the open cell polymer foam comprising a catechol pattern polymer on the surface is partially functionalized by the reducing compound.

According to another aspect, the object of the invention is a process for synthesizing a reducing composition according to the invention comprising a step of contacting the open-cell polymer foam comprising the catechol-patterned polymer on the surface, and an aqueous solution comprising the reducing compound, characterized in that: the pH of the aqueous solution at the beginning of the contacting step is adjusted to at least 7, in particular from 7 to 14, more particularly from 8 to 12, and more particularly still between 9 and 11.

The object of the invention is also the use of the reduction kit according to the invention, of the reducing composition according to the invention or obtained according to the synthesis method according to the invention, as a reagent of a reduction reaction.

### DETAILED DESCRIPTION OF THE INVENTION

Reduction Kit

The present invention relates to a reduction kit comprising:
on the one hand, a reducing compound, and
on the other hand an open cell polymer foam comprising a catechol pattern polymer on the surface.

As used herein, “reducing compound” refers to a chemical compound that yields at least one electron to another chemical compound in a redox reaction. A reducing compound according to the invention is not a catalyst.

As used herein, “open-cell polymer foam” refers to a polymerized solid dispersion in which a large amount of gas is dispersed to form open cells or open porosity, wherein a gas or liquid may pass through the polymer foam and open cells from one side to the other. The open-cell polymer foam implemented in the kit according to the invention may comprise closed cells. Unlike a membrane, defined by the International Union of Pure and Applied Chemistry (IUPAC) as a structure whose lateral dimensions (length and width) are much greater than its thickness, the open cell polymer foam implemented in the reduction kit according to the invention is a structure whose lateral dimensions are of the same order of magnitude as its thickness.

As used herein, “catechol polymer” means a polymer obtained by polymerizing a compound having an optionally substituted catechol (1,2-dihydroxybenzene) unit.

In the remainder of the application, an open-cell polymer foam comprising a catechol-patterned polymer on the surface may be designated by the expression “foam comprising a polymer on the surface”.

Typically the reducing compound may be selected from a non-metallic compound such as hydrogen, a hydride, a compound such as Na₂SO₃, Na₂S₂O₄, Na₂S₂O₃ or N₂H₄, and mixtures thereof.

Typically a hydride is a chemical compound consisting of at least one hydrogen atom and at least one other less electronegative atom.

According to one embodiment, the reducing compound is a hydride chosen from among LiBH₄, NaBH₄, KBH₄, NaBH₃CN, LiH, NaH, KH, CaH₂, BH₃, LiAlH₄, AlH₃, GaH₃, InH₃, TIH₃, a dialkylaluminum hydride, such as diisobutylaluminum (DIBAL), their derivative and their mixture. Preferably the reducing compound is NaBH₄.

Typically, in the reduction kit according to the invention, the reducing compound may be solid, liquid, gaseous. It may be dissolved in an organic or aqueous solvent.

According to a preferred embodiment of the reduction kit according to the invention, the reducing compound is included in a reducing solution, wherein the concentration of reducing compound in the reducing solution may typically be from 0.001 mold to 14.7 mold, preferably 0.001 mold to 1 mold, and more preferably still 0.01 mold to 0.5 mold.

According to one embodiment, the foam comprising a polymer on the surface is chosen from an expanded polypropylene foam comprising a catechol-patterned polymer on the surface, a polystyrene foam comprising a catechol-patterned polymer on the surface, a polyurethane foam comprising a catechol-patterned polymer on the surface, a polydimethylsiloxane (PDMS) foam comprising a catechol-patterned polymer on the surface, a PVC (polyvinyl chloride) foam comprising a catechol-patterned polymer on the surface and their mixture, preferably a polyurethane foam comprising a polymer with a catechol pattern on the surface.

Advantageously, the polyurethane foam may be prepared in high tonnage and at low cost by methods well known to those skilled in the art, typically by a polymerization reaction between an isocyanate and an alcohol. The polyurethane foam used is flexible and robust against mechanical stress. In addition, the crosslinking of the polyurethane allows the use of these supports in certain organic solvents. Polyurethane foams are very light, unlike many other substrates for catalysis, which makes their handling, transport and use very easy. Polyurethane foams are also excellent sound and heat insulators. Finally, the biocompatible nature of this material allows the use of these foams in biological environments.

Typically, the mean equivalent diameter of the opening of the cells, also called size of the “windows”, or size of the “pores” of the foam comprising a polymer on the surface may be from 50 μm to 5000 μm, in particular from 100 μm to 4000 μm, more particularly from 200 μm to 3000 μm.

The mean equivalent diameter of the opening of the cells of the foam comprising a polymer on the surface may be determined by optical, electronic or tomographic microscopy.

Typically, the hydrodynamic porosity (i.e. the ratio of the volume directly accessible by a gas or liquid fluid (which would pass through the foam from side to side) with respect to the total volume of the open cell foam) may be 0.5 to 0.99, especially 0.7 to 0.99, more preferably 0.8 to 0.98.

The hydrodynamic porosity of the foam comprising a polymer on the surface may be determined by a porosimeter, or by the method of moving fluids, or by permeability measurements.

Typically, the compound comprising a catechol unit that makes it possible to obtain the catechol-patterned polymer by polymerization, is chosen from among catecholamines or polyphenols such as caffeic acid, catechol, catechol and its stereoisomers, epigallocatechin, epigallocatechin gallate, hydroxyhydroquinone, morine (2′,3,4′,5,7-pentahydroxyflavone), pyrogallol, tannic acid, and mixtures thereof.

According to a preferred embodiment, the compound comprising a catechol unit is chosen from among catecholamines, i.e. from compounds comprising a catechol unit whose benzene group comprises an optionally substituted alkylamine side chain. Adrenaline, 3,4-dihydroxyphenyl-L-alanine, dopamine (4-(2-aminoethyl) benzene-1,2-diol) or a derivative thereof, adrenaline, norepinephrine, L-DOPA, ephedrine, norephedrine, epinephrine, and their mixture, are catecholamines that are suitable for the present invention.

According to a preferred embodiment, the catecholamine is dopamine, a derivative thereof or a mixture thereof.

According to a particularly preferred embodiment, the catechol-patterned polymer is polydopamine.

Advantageously, polydopamine is nontoxic, environmentally friendly, and has reducing properties (antioxidants).

According to a particularly preferred embodiment of the reduction kit according to the invention, the reducing compound is NaBH₄, the foam comprising a polymer on the surface is a polyurethane foam comprising polydopamine on the surface.

The reduction kit according to the invention has reducing properties, mainly conferred by the reducing compound, even if the catechol-patterned polymer may also have reducing properties.

Given these reducing properties, the reduction kit according to the invention may be used as a reagent of a reduction reaction.

During the reduction reaction, the reducing compound and the foam comprising a polymer surface are used together. Depending on the method used, they may be contacted simultaneously or sequentially with the compound to be reduced.

Advantageously, the reducing properties of the reduction kit according to the invention are superior to the reducing properties of the reducing compound and of the foam comprising a polymer on the surface used separately. Thanks to this increase in reducing properties, the reduction kit according to the invention makes it possible to speed up the reduction methods as well as to greatly reduce the amount of reducing compound required for a reduction reaction, and therefore the amount of secondary residual product (oxidized reducing agent, boron salts in the case of the use of NaBH₄ as a reducing compound).

During the reduction reaction, the cells of the foam comprising a polymer at the surface are as many mini-reactors favoring an intimate mixing of the reagents within the foam comprising a polymer at the surface. The foam comprising a polymer of the reduction kit according to the invention on the surface, thus promotes the reduction reactions under mild conditions of temperature and pressure.

The foam comprising a polymer on the surface has a large and open hydrodynamic porosity. The passage of reagents, gaseous or liquid of a reduction reaction, through the foam comprising a polymer surface is possible and favored even at low pressure.

When the foam comprising a polymer on the surface is used in a continuous process, the pressure drop is advantageously limited thanks to the morphological properties of the foam comprising a polymer on the surface (size of the cells (or pores), and hydrodynamic porosity (or open)).

Thanks to the cross-linking of the polymer chains that constitute it, the foam has an elastic character.

The elastic character of the foam is preserved when it comprises a polymer on the surface (Chem. Commun 2016, 52, 4691).

Advantageously, this elasticity makes it possible to adapt the foam comprising on the surface a polymer of the reduction kit according to the invention to all types of reactors, even unconventional reactors. Its resistance to mechanical stresses also makes it easier to transport and store.

The combination of mechanical and chemical resistance and elasticity allows the foam comprising a polymer on the surface to not deteriorate during the reduction reactions. The foam comprising on the surface a polymer of the reduction kit according to the invention may therefore be used several times without degrading.

When the catechol-patterned polymer is polydopamine, then, and without wishing to be bound by any theory, the inventors are of the opinion that when the reduction kit is used as a reagent for a reduction reaction, the reducing properties of polydopamine stabilize the reducing compound present in the reduction kit according to the invention and/or act as a redox mediator for the reduction reaction. The amount of reducing compound required for the reduction reaction is, therefore, advantageously greatly reduced.

By virtue of these properties and the advantages resulting therefrom, the foam comprising on the surface a polymer of the reduction kit according to the invention is suitable for use on an industrial scale, in particular when it comprises polydopamine on the surface. As previously described, the reducing compound and the foam comprising on the surface a polymer of the reduction kit according to the invention, are used together during the reduction reaction. During this joint use, the foam comprising a polymer on the surface may be partially functionalized by the reducing compound.

Advantageously, the functionalization of the foam comprising a polymer on the surface makes it possible to easily separate the products obtained during the reduction reaction.

Reducing Composition

The invention also relates to a reducing composition comprising:
a reducing compound,
an open-cell polymer foam comprising on the surface a catechol-patterned polymer,

characterized in that the open-cell polymer foam comprising on the surface a catechol-patterned polymer, is partially or fully functionalized by the reducing compound.

According to a preferred embodiment, the open-cell polymer foam comprising on the surface a catechol-patterned polymer, is functionalized by the reducing compound.

The open-cell polymer foam comprising a catechol-patterned polymer on the surface, the reducing compound and the associated embodiments are as described above in the section relating to the reduction kit according to the invention.

Without wishing to be bound by any theory, the inventors are of the opinion that the functionalization of the open-cell polymer foam comprising on its surface the catechol-patterned polymer, by the reducing compound, is obtained by one or more of the following chemical phenomena:
the adsorption of the reducing compound by the open cell polymer foam comprising on its surface the catechol-patterned polymer,
the reaction of the reducing compound on the surface of the open cell polymer foam comprising on its surface the catechol-patterned polymer leading to the formation of one or more covalent bonds between the hydroxyl groups of the catechol unit and the reducing compound, and
when the catechol-patterned polymer present on the surface of the open-celled polymer foam is obtained by polymerization of a catecholamine, the presence of positively charged amine groups (ammoniums) may allow the electrostatic complexation with the negatively charged reducing compound (borohydride ion, BH₄⁻).

For the purposes of the present application, a reducing composition in which “the open-cell polymer foam comprising on the surface a catechol-patterned polymer is partially functionalized by the reducing compound” refers to a reducing composition in which:
a portion of the reducing compound functionalizes the open-cell polymer foam comprising on the surface a catechol-patterned polymer,
the other portion of the reducing compound is free.

For the purposes of the present application, a reducing composition in which “the open-cell polymer foam comprising on the surface a catechol-patterned polymer, is completely functionalized by the reducing compound” refers to a reducing composition in which the whole of the reducing compound functionalizes the open cell polymer foam comprising on the surface a catechol pattern polymer.

The reducing composition according to the invention has reducing properties, mainly conferred by the reducing compound, even if the catechol-patterned polymer may also have reducing properties.

Given these reducing properties, the reducing composition according to the invention may be used as a reagent of a reduction reaction.

The reducing properties of the reducing composition according to the invention are superior to the reducing properties of the reducing compound and of the foam comprising on the surface a polymer used separately.

The functionalization of the foam comprising a polymer on the surface makes it possible to stabilize the reducing compound. Stabilization avoids degradation of the reducing compound under the partially aqueous conditions of a reduction reaction. Stabilization also makes it possible to repeatedly use the reducing composition according to the invention without having to refunctionalize the foam comprising on the surface a polymer by the reducing compound after each use of the reducing composition according to the invention. It also makes it possible to store the modified foam over time and to use it later without losing activities.

Due to its superior reducing properties and functionalization, the amount of reducing compound required for a reduction reaction is greatly reduced when using the reducing composition in a reduction reaction.

According to one embodiment, the reducing composition according to the invention comprises from 10 mg/kg to 5000 mg/kg, in particular from 1000 mg/kg to 2500 mg/kg, more particularly from 1500 mg/kg to 1700 mg/kg of reducing compound relative to the total mass of the reducing composition.

This amount is much less than the amount used in conventional industrial reduction methods where the reducing compound is used in excess.

The amount of reducing compound in the reducing composition according to the invention may be determined by standard material characterization techniques such as inductively coupled plasma spectrometry (ICP-AES), or by measuring the difference in mass between the foam before and after treatment with the reducing compound.

The amount of reducing compound in the reducing composition according to the invention depends on the conditions used in the method for synthesizing the reducing composition described below.

The functionalization of the foam comprising on the surface a polymer by the reducing compound is favored by the catechol pattern of the catechol-patterned polymer. Advantageously, the catecholamines described above thus promote the functionalization of the foam comprising a polymer on the surface by the reducing compound.

In particular, when the catechol-patterned polymer is polydopamine, then, and without wishing to be bound by any theory, the inventors believe that the reducing properties of polydopamine have an additional stabilizing effect on the reducing compound. This additional stabilization promotes the repeated use of the reducing composition according to the invention and the reduction of the amount of reducing compound necessary for a reduction reaction.

Even more particularly, when the catechol-patterned polymer is polydopamine and the reducing compound is NaBH₄, the inventors are of the opinion that the functionalization by NaBH₄ of the foam comprising on the surface a polymer, is obtained by the formation of boron complexes, typically catecholboranes on the surface of the foam comprising a polymer on the surface. Advantageously, the formation of these complexes and the reducing properties of polydopamine make it possible to stabilize and avoid the degradation of NaBH₄ in an aqueous medium and, consequently, to greatly reduce the amount of NaBH₄ required for a reduction reaction.

By virtue of its physicochemical properties, the reducing composition according to the invention promotes reduction reactions under mild conditions of temperature and pressure, limits the pressure loss in case of high fluxes, is light and flexible and therefore adaptable to all types of reactors, is resistant to mechanical and chemical stresses, can be used repeatedly, greatly reduces the amount of reducing compound required for the reduction reactions and promotes the separation of the products obtained by a reduction reaction.

The reducing composition according to the invention is therefore suitable for use on an industrial scale.

Method for Synthesizing the Reducing Composition According to the Invention

The object of the present invention is also a method for synthesizing the reducing composition according to the invention comprising a step of contacting an open-cell polymer foam comprising, on the surface, a catechol-patterned polymer and an aqueous solution comprising a reducing compound, characterized in that: the pH of the aqueous solution at the beginning of the contacting step is adjusted to at least 7, in particular from 7 to 14, more particularly from 8 to 12, and more particularly still between 9 and 11.

The open cell polymer foam comprising on the surface the catechol pattern polymer and the reducing compound, are as defined above.

The amount of reducing compound in the reducing composition according to the invention depends on the pH of the aqueous solution comprising the reducing compound at the beginning of the contacting step. For pH values below 7 the amount of reducing compound is low and may be greatly increased when this pH at the beginning of the contacting step is greater than 7. Typically, for a boron hydride, when the pH of the aqueous solution at the beginning of the contacting step is adjusted to an acidic value, then the composition obtained by the method according to the invention comprises less than 2.5 mg/kg of boron relative to the total mass of the reducing composition. Typically, when the pH of the aqueous solution at the beginning of the contacting step is adjusted to a value of at least 7, the reducing composition according to the invention comprises from 2.5 mg/kg to 5000 mg/kg, in particular from 1000 mg/kg to 2500 mg/kg, more particularly from 1500 mg/kg to 1700 mg/kg, of boron relative to the total weight of the reducing composition.

The reducing properties of the reducing composition according to the invention depend on the pH of the aqueous solution comprising the reducing compound at the beginning of the contacting step. Typically, when the pH of the aqueous solution at the beginning of the contacting step is adjusted to an acidic value, then the composition obtained according to the method of the invention has reducing properties that are not sufficient for industrial use. Typically, when the pH of the aqueous solution at the beginning of the contacting step is adjusted to a value of at least 7, then the reducing composition according to the invention has reducing properties sufficient for industrial use. The reducing properties of the reducing composition according to the invention increase when the pH of the aqueous solution at the beginning of the contacting step is adjusted to basic and are maximum when the pH is between 9 and 11.

Typically, the foam comprising a polymer on the surface may be obtained according to the method described in the application WO 2016/012689 and in the scientific article Chem. Common. 2016, 52, 4691, or according to the method described in the scientific article Ponzio et al—Chemistry of Materials, 2016 (DOI: 10.1021/acs. chemmater.6b01587). Typically the contacting step may be carried out by introducing the foam comprising a surface polymer in the aqueous solution comprising the reducing compound, or impregnating the foam comprising a polymer surface by the aqueous solution comprising the reducing compound.

The reducing compound concentration of the aqueous solution depends on the mass and the foam dimensions comprising a polymer on the surface. Typically, the reducing compound concentration of the aqueous solution may be from 0.001 mold to 14.7 mold, preferably from 0.05 mold to 1 mold, and more preferably still from 0.01 mold at 0.5 mold.

Advantageously, the synthesis method according to the invention implements aqueous solutions comprising low concentrations of reducing compound. It should be noted that reducing solutions are freshly prepared. In the case of the use of NaBH₄ as a reducing agent, in contrast to the procedures generally described, the use of concentrated sodium hydroxide solution for dissolving NaBH₄ is not necessary.

Typically, the synthesis method according to the invention may be carried out at room temperature. The synthesis method according to the invention is therefore not energy intensive.

Although the duration of the contacting step depends on numerous parameters such as dimensions, cell size, porosity, the foam density comprising a polymer on the surface, or the reducing compound concentration of the aqueous solution, a duration of at least 1 minute, in particular from 2 minutes to 600 minutes, more particularly from 10 minutes to 60 minutes, is sufficient to obtain the reducing composition according to the invention.

The synthesis method according to the invention implements aqueous solutions comprising low concentrations of reducing compound. In addition, it may be implemented at room temperature, so it is not energy intensive. Advantageously, the synthesis method according to the invention is respectful of the environment.

The reducing composition obtained by the synthesis method according to the invention has reducing properties. The reducing composition obtained by the synthesis method according to the invention may be used as a reagent of a reduction reaction.

According to one embodiment, the reduction kit according to the invention, the reducing composition according to the invention or obtained by the synthesis method according to the invention, may be used as a reagent in a reduction reaction.

By way of examples of reduction reactions, mention may be made of:
the reduction of dyes or pigments, such as methylene blue, eosin, indigo;
the reduction of insecticides, pesticides or herbicides, such as paraquat, diquat, difenzoquat, paraoxon;
the reduction of an aldehyde such as benzaldehyde or cinnamaldehyde;
the reduction of ketones to alcohols, imines, hydrazones, thioesters, acyl chlorides;
the reduction of sulfur oxides, such as sulfur dioxide for the production of sodium dithionite;
the reduction of a metal precursor for the formation of a metal particle, wherein the metal precursor is possibly chosen from among a salt or complex of Ag, Au, Ce, Co, Fe, Ir, Ni, Pd, Pt, Rh, Ru, Sn, W, Zn and their mixture.

The reduction kit according to the invention, the reducing composition according to the invention or obtained by the synthesis method according to the invention may be used for the purification of wastewater comprising toxic metals, organic compounds and/or dyes.

The reduction kit according to the invention, the reducing composition according to the invention or obtained by the synthesis method according to the invention, may be used for the storage and/or the production of hydrogen.

The invention will be described in more detail with the aid of the following examples given by way of illustration only and the accompanying figures.

### DESCRIPTION OF THE FIGURES

FIG. 1 shows two images of Scanning Electron Microscopy (SEM). On the left, a polyurethane foam, on the right, a polyurethane foam comprising polydopamine on the surface (see Example 1).

FIG. 2 shows a graph illustrating the evolution of the reduction rate of methylene blue (MB) by six different samples (A-F, see Example 3) as a function of time.

FIG. 3 shows a graph illustrating the repeated use of the reduction kit according to the invention for the reduction of MB.

FIG. 4 shows a graph illustrating the repeated use of the reducing composition according to the invention for the reduction of MB.

FIG. 5 shows a graph illustrating the evolution of the reduction rate of MB by the reducing composition according to the invention (A) and two commercial products (G and H).

FIG. 6 shows an SEM of a reducing composition according to the invention comprising silver nanoparticles on the surface.

FIG. 7 shows a graph illustrating the total mass of reduced MB by reducing compositions according to the invention, which were synthesized with aqueous solutions of NaBH₄ of different pH (5, 7, 10 and 12).

FIG. 8 shows the evolution over time of the ratio r=Area (benzyl alcohol)/[Area (benzyl alcohol)+Area (benzaldehyde)] measured by HPLC coupled to a UV-visible spectrophotometer.

### EXAMPLES

### Example 1: Synthesis of a Polyurethane Foam Comprising the Surface of Polydopamine

The polyurethane foam is a sample of Regicell® 20 foam (Foampartner®) of 8 cm³ and about 200 mg.

An aqueous solution of dopamine hydrochloride is prepared by dissolving dopamine hydrochloride (2 mg/ml) in an aqueous solution (60 ml) of tris (hydroxymethyl) aminomethane (TRIS) at a molar concentration of 10 mM, the pH of which is adjusted to 8.5 by dropwise addition of 1M of HCl aqueous solution.

The polyurethane foam is immersed at room temperature for 24 hours in the stirred aqueous solution of dopamine in an illuminated room. The dopamine polydopamine polymerization is characterized by a change in the color of the aqueous solution to dark brown. The polyurethane foam comprising polydopamine on the surface is then rinsed with ultrapure water (MiliQ).

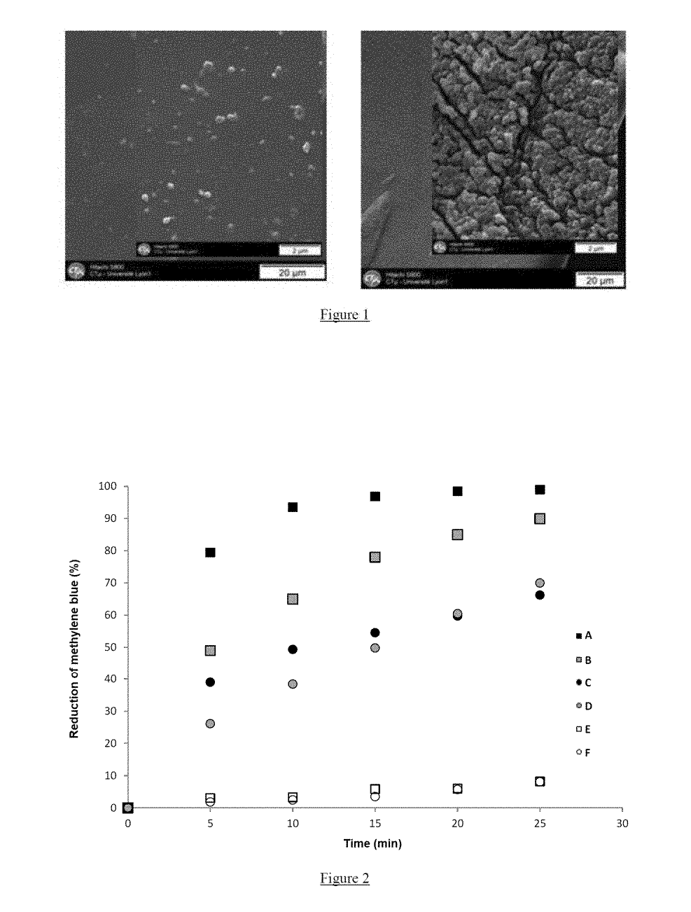

Foam surface analysis obtained by X-ray photoelectron spectroscopy (XPS) and SEM images (see FIG. 1) confirm the presence of a uniform polydopamine coating on the surface of the polyurethane foam. The mass of polydopamine on the surface of the polyurethane foam is about 2 mg.

The foam obtained in this example is therefore a polyurethane foam comprising polydopamine on the surface.

### Example 2: Synthesis of the Reducing Composition in Which the Reducing Compound is NaBH₄

The polyurethane foam comprising polydopamine on the surface of Example 1 is immersed, at room temperature and for 10 minutes, in a stirred aqueous solution of 150 ml comprising 0.1 mold of NaBH₄ and whose pH is 10. The functionalization of the polyurethane foam comprising polydopamine on the surface is characterized by the appearance of a slight yellow coloration of the aqueous solution and a low production of H₂(g).

The amount of boron from NaBH₄ in the reducing composition is measured by ICP-AES. This amount is about 1600 mg/kg of reducing composition.

The reducing composition obtained in this example therefore comprises a polyurethane foam comprising polydopamine on the surface functionalized with NaBH₄.

### Example 3: Evaluation of the Reducing Properties of the Reduction Kit and the Reducing Composition According to the Invention During the Reduction of Methylene Blue (MB)

The reduction properties of six different but related mass samples (i.e. 200±20 mg) were evaluated during BM reduction.

List of tested samples:
A: reducing composition according to the invention of Example 2,
B: reduction kit according to the invention comprising the foam of Example 1+aqueous solution of NaBH₄ (15 ml, 0.1 mol/l of NaBH₄)
C: polyurethane foam with NaBH₄ adsorbed on the surface
D: polyurethane foam+aqueous solution of NaBH₄ (15 ml, 0.1 mol/l of NaBH₄)
E: foam of Example 1
F: polyurethane foam

Six 50 ml MB solutions are prepared. The concentration of MB in these solutions is 2.10⁻⁵ mol/l of MB.

One of the six samples is immersed in one of six stirred MB (with agi700 rpm) of MB (50ml) solutions at room temperature. For samples B and D, the aqueous solution of NaBH₄ is added together with the foam of Example 1 or polyurethane. For samples A, C, E and F, no NaBH₄ solution is added.

The variation of MB concentration in the MB solution is monitored for 25 minutes. Every 5 minutes a sample of MB solution is taken. The sample is then analyzed by spectrophotometry at the wavelength of 664 nm, which is the maximum absorption wavelength of the MB (UV-Vis Varian 50 Probe spectrophotometer).

The reduction rate (%) of MB is calculated according to the following formula:

R(%)=100*(1−C_{MB}(t)/C_{MB}(0))

wherein R is the BM reduction rate, C_{MB}(0) is the initial MB concentration in the MB solution, and C_{MB}(t) is the MB concentration at the instant tin the MB solution.

The evolution over time of MB reduction is shown in FIG. 2.

As the graph in FIG. 2 shows, after 25 minutes:
the sample A (reducing composition according to the invention) reduced 99% of MB, of which 80% after 5 min
the sample B (reduction kit according to the invention) reduced 90% of MB, of which 50% after 5 min
samples C and D reduced between 65% and 70% of MB, of which respectively 40% and 25% after 5 min
samples E and F reduced less than 10% of MB, of which 2% after 5 min

In the case of sample A, more than 90% of MB is reduced after only 10 minutes.

The polyurethane foam and the foam of Example 1 degrade only very little MB. The reduction of MB by samples C and D therefore results from adsorbed NaBH₄ and aqueous NaBH₄ solution, respectively.

As illustrated by FIG. 2 and the evolutions of the MB reduction rates by the samples A and B, the combination of the polyurethane foam comprising on the surface of the polydopamine and the NaBH₄ confers on the reducing composition of the invention (sample A) and the reduction kit of the invention (sample B) reducing properties that are superior to the reducing properties of the foam of Example 1 alone, of the polyurethane foam alone, or in combination with the aqueous solution of NaBH₄ or the adsorbed NaBH₄ surface.

### Example 4: Evaluation of the Repeated Use of the Reduction Kit According to the Invention During the Reduction of Methylene Blue (MB)

The repeated use of the reduction kit according to the invention was evaluated. The reduction kit tested is sample B of Example 3.

The protocol followed is as follows:
five MB solutions (50 ml and 2.10⁻⁵ mold of MB), numbered from 1 to 5, are prepared,
five aqueous solutions of NaBH₄ (15 ml, 0.1 mold of NaBH₄), numbered from 1 to 5, are freshly prepared before each use, the foam of Example 1 is immersed in the solution of MB_1 with stirring and the aqueous solution of NaBH₄_{_}1 is added simultaneously,
the rate of reduction of MB in the MB_1 solution is followed according to the protocol of Example 3 for 25 minutes, after 25 minutes, the foam of Example 1 is removed from the MB_1 solution and then immersed in the MB_2 solution and the aqueous solution of NaBH₄_{_}2 is added simultaneously. The MB reduction rate in the MB_2 solution is followed according to the protocol of Example 3 for 25 minutes.
etc . . . . until the MB_5 solution.

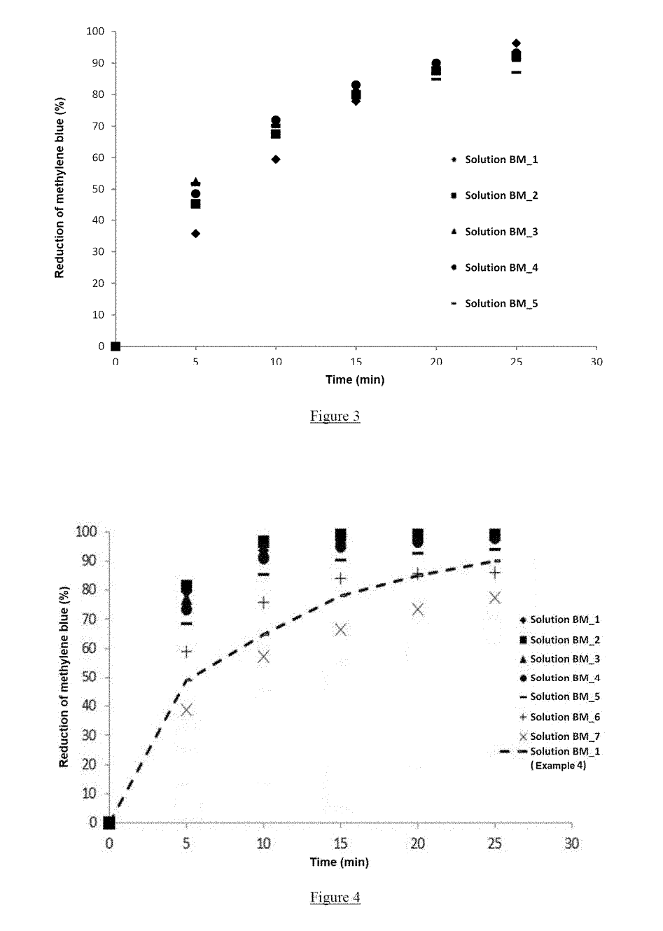

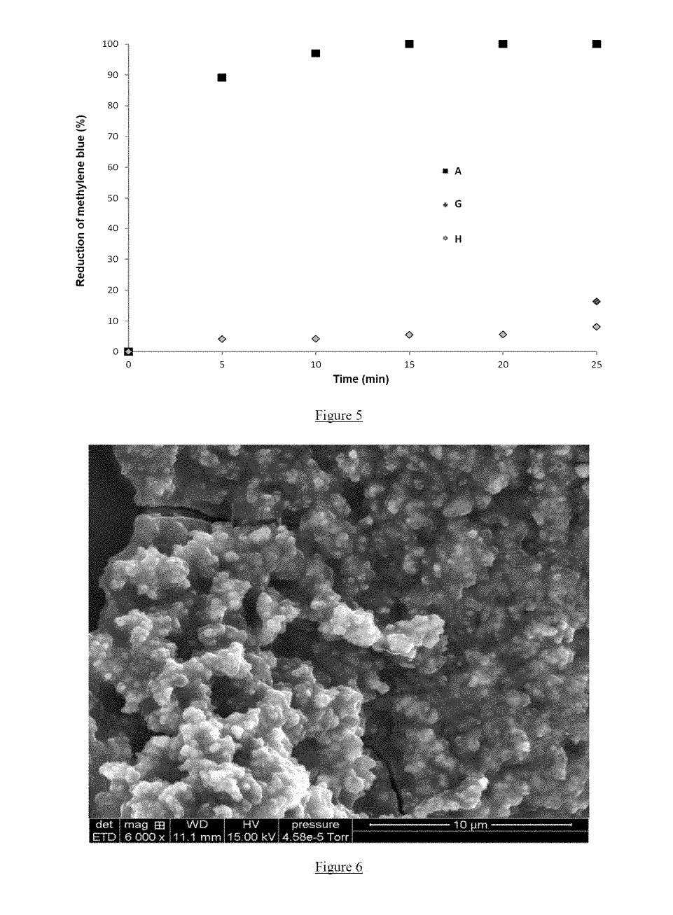

The time course of the MB reduction rate for the MB_1 to 5 solutions is shown in FIG. 3.

As shown in FIG. 3, the change over time in the MB reduction rate is similar for solutions from MB_1 to 5.

The morphology of the foam of Example 1 was not impaired by these repeated immersions. The reduction kit according to the invention may therefore be used repeatedly (at least 5 times).

With samples C and D of Example 3, a single immersion is effective in terms of reduction of methylene blue. Unlike the reduction kit according to the invention, samples C and D of Example 3 can not be used repeatedly.

### Example 5: Evaluation of the Repeated Use of a Single Reducing Composition According to the Invention of Example 2 During the Reduction of Methylene Blue (MB)

The repeated use of the reducing composition according to the invention was evaluated. The reducing composition tested is that of Example 2.

The protocol followed is similar to Example 4. The differences are as follows:
seven MB solutions (50 ml and 2.10⁻⁵ mold of MB), numbered from 1 to 7, are prepared, and
no aqueous solution of NaBH₄ is prepared and added to the solutions of MB_1 to 7.

The time course of the MB reduction rate for the MB_1 to 7 solutions is shown in FIG. 4. The change over time in the reduction rate of the MB in the MB_1 solution by the reduction kit according to the invention (see Example 4) is also shown.

As illustrated in FIG. 4, the change over time in the MB reduction rate is similar in the MB_1 to 5 solutions and this MB reduction rate is higher than that obtained by the reduction kit according to the invention in the MB_1 solution.

In the MB_6 solution, the reduction kinetics of the MB is slowed down a little and the reduction rate is less important than that obtained by the reducing composition according to the invention in the solutions of MB_1 to 5. However during the first 15 minutes, this reduction rate is higher than that obtained by the reduction kit according to the invention in the MB_1 solution, and is of the same order of magnitude.

In the MB_7 solution, the kinetics of MB reduction is slowed down but, after 25 minutes, the reduction rate is about 80% without a plateau being reached, which suggests that over a longer period, a higher rate of reduction could be achieved.

In addition, the morphology of the reducing composition of Example 2 was not impaired by these repeated immersions.

This example demonstrates that the reducing composition according to the invention may be used repeatedly without adding NaBH₄. With the samples C and D of Example 3, only one immersion allows the reduction of methylene blue. Unlike the reduction kit according to the invention, samples C and D of Example 3 can not be used repeatedly. Advantageously, this greatly reduces the amount of NaBH₄ used to reduce methylene blue.

### Example 6: Comparison of the Reducing Properties of the Reducing Composition According to the Invention of Example 2 with Commercial Products in the Reduction of Methylene Blue (MB)

The reduction properties of three different samples were evaluated according to the protocol described in Example 3.

List of tested samples:
A: reducing composition according to the invention of Example 2,
G: NaBH₄ supported on alumina (Ref: 243620 ALDRICH)
H: NaBH₄ supported on balls of polymer material (Ref: 328642 ALDRICH)

The evolution over time of the MB reduction rate is shown in FIG. 5.

As the graph in FIG. 5 shows, after 25 minutes:
the sample A (reducing composition according to the invention) reduced 99% of MB
sample G was reduced less than 20% of MB, and
sample H was reduced less than 10% of MB.

As illustrated by FIG. 5 and the evolutions of the MB reduction rates by the three samples, the combination of the polyurethane foam comprising, on the surface of the polydopamine functionalized with NaBH₄, gives the reducing composition of the invention superior reducing properties compared with the two commercial products tested.

### Example 7: Evaluation of the Reducing Properties of the Reducing Composition According to the Invention of Example 2 for the Synthesis of Silver Nanoparticles (NpAg)

The reducing properties of the reducing composition according to the invention were studied during the synthesis of silver nanoparticles.

The reducing composition of Example 2 was immersed, with stirring in an aqueous solution of AgNO₃ at 50 mmol/l for 24 hours at room temperature. The reducing composition is then removed from the aqueous solution of AgNO₃ and then rinsed with ultrapure water (MiliQ).

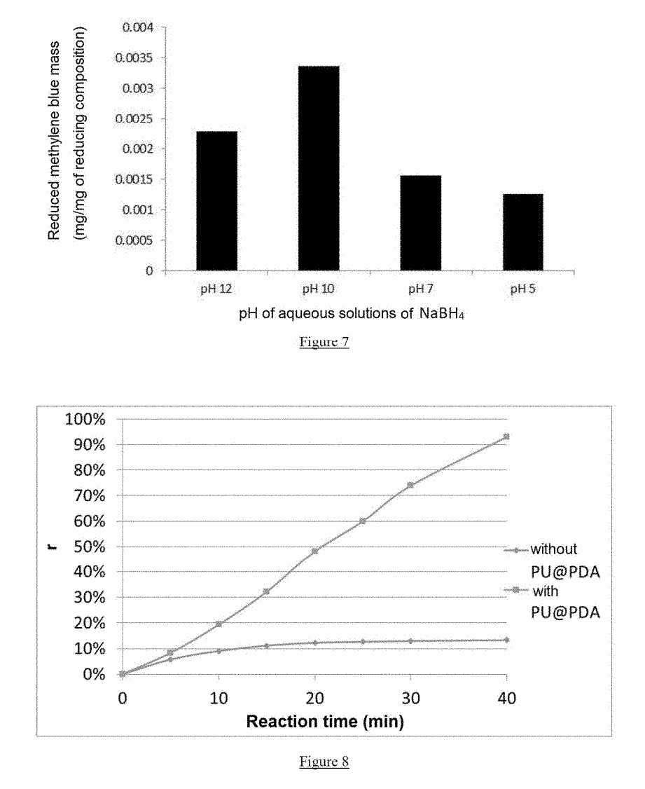

The SEM image of FIG. 7 confirms the presence of silver nanoparticles on the surface of the reducing composition. An EDX (Energy Dispersive X-ray) analysis of this SEM image as well as mass measurements make it possible to determine that the silver mass on the surface of the reducing composition is about 17.5 mg.

The reducing composition obtained in Example 7 thus comprises a polyurethane foam comprising polydopamine on the surface functionalized with NaBH₄ and silver nanoparticles.

When the reducing composition of Example 2 according to the invention is used for the synthesis of silver nanoparticles, then, and without wishing to be bound by any theory, the inventors are of the opinion that when the reducing composition is used as the reducing agent, the reducing properties of polydopamine reduce Ag⁺ ions stabilize and protect from oxidation the silver particles (0) present on the surface of the reducing composition.

### Example 8 Study of the Effect of the pH of the Aqueous Solution of NaBH₄ on the Amount of NaBH₄ in the Reducing Composition According to the Invention and the Reducing Properties of the Reducing Composition According to the Invention

a) Synthesis and Characterization of the Compositions

The synthesis protocol is similar to that of Example 2, the difference being that four solutions of NaBH₄ were prepared by adjusting their pH to 5, 7 and 10.

After the synthesis of four reducing compositions according to the invention, their amount of boron from NaBH₄ is determined by ICP-AES.

The results are shown in the following table.

| | Aqueous | Aqueous | Aqueous |
|---|---|---|---|
| Solution | solution pH 5 | solution pH 7 | solution pH 10 |
| Amount of B in | 1.6 | 2.1 | 1607 |
| the composition | | | |
| (mg/kg) | | | |

b) Study of the Reducing Properties of the Compositions, Reduction of Methylene Blue

The reducing properties of these compositions are then evaluated during the reduction of methylene blue (MB). The protocol followed is that of Example 3.

The total mass of reduced MB is calculated from MB reduction rates, and is represented on the histogram of FIG. 7.

As shown in the histogram of FIG. 7, the total mass of reduced MB is limited when the pH of the aqueous solution is 5, wherein it increases when the pH of the aqueous solutions is 7 and 10, and it is maximum when the pH of the aqueous solution is equal to 10.

This example thus demonstrates that the reduction properties of the composition synthesized with the aqueous solution of pH=5 are not sufficient for industrial use, whereas the reducing properties of the reducing compositions according to the invention synthesized with the aqueous solutions pH=7 and 10 are sufficient for industrial use.

c) Studies of the Reducing Properties of the Reducing Compositions Synthesized with Aqueous Solutions of pH=10 and pH=5, Synthesis of Silver nanoparticles (NpAg)

The reducing properties of the reducing compositions according to the invention obtained with the aqueous solutions of pH=10 and pH=5 are then evaluated for the synthesis of silver nanoparticles (NpAg). The protocol followed is that of Example 7.

The silver mass on the surface of the reducing composition obtained from the solution of pH=10, measured as described in Example 7, is about 17.5 mg. The silver mass on the surface of the reducing composition obtained from the pH=5 solution is about 2.3 mg.

### Example 9: Evaluation of the Reducing Properties of the Reduction Kit of the Invention During the Benzaldehyde Reduction Reaction to Benzyl Alcohol

The reduction of benzaldehyde by the reduction kit was evaluated as follows. The polyurethane foam coated with polydopamine used is that described in Example 1 (volume of the foam used: 30 cm³). The NaBH₄ solution is freshly prepared before use. A quantity of 114 mg of NaBH₄ is dissolved in ultrapure water (1.0 mL, without the use of sodium hydroxide) and then this reducing solution is immediately added to the foam of the reduction kit suspended in a 1000 mL of methanolic solution of benzaldehyde. The concentration of benzaldehyde is 9.44 mM. It should be noted that the amount of NaBH₄ used represents 0.32 molar equivalents relative to the amount of benzaldehyde, i.e. 1.28 equivalents of hydrides. The conversion of benzaldehyde to benzyl alcohol takes place at room temperature and was followed by HPLC chromatography coupled with a UV-visible spectrophotometer (Column SUPELCOSIL ABZ+PLUS 3 μM 15CM×4.6MM HPLC (Sigma-Aldrich), isocratic eluent H₂O+0.1% TFA 60/40 acetonitrile, 1 mL/min flow rate, 250 nm detection for benzaldehyde and benzyl alcohol). The reaction medium is removed and then analyzed by HPLC every 3 minutes: the evolution of the proportion of benzyl alcohol formed as well as the reduction of the proportion of starting benzaldehyde is monitored thanks to the retention times characteristic of benzaldehyde (t=4.4 min) and benzyl alcohol (t=3.1 min) under the analytical conditions used. No other peak is observed on the chromatogram. The evolution over time of the area ratio r represented in FIG. 8 is defined as follows:

r=Area (benzyl alcohol)/[Area (benzyl alcohol)+Area(benzaldehyde)]

Two curves are present in FIG. 8: one curve showing the evolution of r using the reduction kit and a curve without a reduction kit but with an equivalent quantity of NaBH₄ in both cases. In the absence of the polyurethane foam coated with polydopamine, the reduction of benzaldehyde to benzyl alcohol by direct reaction of NaBH₄ is linear and very slow: after 40 minutes, a 13% conversion to benzyl alcohol is measured. When the reduction kit is used, it leads to a rapid reduction reaction: after 40 minutes, a 93% conversion to benzyl alcohol is measured.

### Example 10: Evaluation of the Reducing Properties of the Reductive Composition of the Invention of Example 2 in the Benzaldehyde Reduction Reaction

The reducing composition was prepared using a solution of 10 mL of 22% NaBH₄, 22% NaOH and 56% pure water (weight ratio). The polyurethane foam was soaked in this solution for 1 minute with stirring and then dried with compressed air. This foam was immersed in a first methanolic solution of benzaldehyde at 9.8 μM with stirring and at room temperature, and then identically in a second methanolic B solution of benzaldehyde at 9.8 μM. The conversion to benzyl alcohol was determined by HPLC as described in Example 9. The ratio r is determined after 10 minutes of reaction in solution A and B because beyond this time, the conversion no longer evolves. It is 100% conversion to benzyl alcohol in solution A and 70% in solution B.

1-11. (canceled)

12. A reduction kit comprising:
a reducing compound, and
an open cell polymer foam and comprising on the surface a catechol pattern polymer.

13. The reduction kit according to claim 12, wherein the reducing compound is selected from a non-metallic compound, hydrogen, a metal compound, a hydride, Na SO₃, Na₂S₂O₄, Na₂S₂O₃ or N₂H₄, and their mixture.

14. The reduction kit according to claim 12, wherein the reducing compound is a hydride selected from LiBH₄, NaBH₄, KBH₄, NaBH₃CN, LiH, NaH, KH, CaH₂, BH₃, AlH₃, GaH₃, InH₃, T1H₃, a dialkylaluminum hydride, diisobutylaluminum hydride (DIBAL), their derivative and their mixture.

15. The reduction kit according to claim 12, wherein the reducing compound is solid, liquid or gaseous.

16. The reduction kit according to claim 12, wherein the reducing compound is included in a reducing solution, the concentration of reducing compound in the reducing solution being from 0.001 mol/l to 14.7 mol/l.

17. The reduction kit according to claim 12, wherein the open cell polymer foam comprising on the surface a catechol pattern polymer is selected from an expanded polypropylene foam comprising on the surface a catechol pattern polymer, a polystyrene foam comprising on the surface a catechol-patterned polymer, a polyurethane foam comprising on the surface a catechol-patterned polymer, a polydimethylsiloxane (PDMS) foam comprising on the surface a catechol-patterned polymer, a PVC (polyvinyl chloride) foam) comprising on the surface a catechol-patterned polymer and their mixture.

18. The reduction kit according to claim 12, wherein the catechol pattern polymer present on the surface of the open-cell polymer foam is obtained by polymerization of a compound comprising a catechol unit selected from catecholamines or polyphenols, caffeic acid, catechol, catechin and its stereoisomers, epigallocatechin, epigallocatechin gallate, hydroxyhydroquinone, morine (2′,3,4′,5,7-pentahydroxyflavone), pyrogallol, tannic acid, and their mixture.

19. The reduction kit according to claim 12, wherein the catechol-patterned polymer present on the surface of the open-cell polymer foam is polydopamine.

20. A reducing composition comprising:
a reducing compound selected from a non-metallic compound, hydrogen, a metal compound, a hydride, Na SO₃, Na₂S₂O₄, Na₂S₂O₃ or N₂H₄, and their mixture,
an open-cell polymer foam comprising on the surface a catechol-patterned polymer selected from an expanded polypropylene foam comprising on the surface a catechol pattern polymer, a polystyrene foam comprising on the surface a catechol-patterned polymer, a polyurethane foam comprising on the surface a catechol-patterned polymer, a polydimethylsiloxane (PDMS) foam comprising on the surface a catechol-patterned polymer, a PVC (polyvinyl chloride) foam) comprising on the surface a catechol-patterned polymer and their mixture,
wherein the open-cell polymer foam comprising at the surface a catechol-patterned polymer is partially or fully functionalized by the reducing compound.

21. The method for synthesizing a reducing composition as defined in claim 20 comprising a step of contacting the open-cell polymer foam comprising the catechol-patterned polymer on the surface, and an aqueous solution comprising the reducing compound, wherein the pH of the aqueous solution at the beginning of the contacting step is adjusted to at least 7.

22. A reagent of a reduction reaction comprising the reduction kit as defined in claim 12.
